(19) United States
(12) Patent Application Publication
(10) Pub. No.: US 2005/0076149 A1
(43) Pub. Date: Apr. 7, 2005

(54) Method and apparatus for providing broadband wireless access services using the low voltage power line

(75) Inventors: Russell C. McKown, Richardson, TX (US); Salvador Lopez, Dundee, IL (US); Robert R. Nelson, Dallas, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: MacPhy Technologies, Inc.

(21) Appl. No.: 10/728,101

(22) Filed: Dec. 4, 2003

Related U.S. Application Data
(60) Provisional application No. 60/430,990, filed on Dec. 4, 2002.

(51) Int. Cl. G06F 15/16

(52) U.S. Cl. 709/249; 333/24 R; 340/310.01

(57) ABSTRACT

A single subscriber station of a wireless metropolitan area network is shared among multiple households through a local AC power line that serves the households. The WMAN is connected to a power line network through a dual medium bridge modem located, for example, in the general proximity of a power transformer.

### BACKGROUND OF INVENTION

The two primary economic barriers to the development of fixed broadband wireless access (FBWA) have been the cost of the customer-premise equipment (CPE) and the cost of its installation. The cost of FBWA CPE with an outdoor mounted antenna routinely exceeds $1000. This is expensive in comparison to telephone digital subscriber loop (DSL) CPEs and cable broadband access modem CPEs which are in the range of $75. Although microelectronic circuit integration and large production runs will help lower the cost of FBWA CPE, the cost for existing products and technologies is expected to remain an economic problem for the industry. A related barrier is CPE installation which requires an expensive truck roll with a trained technician to set up the outdoor antenna and install new wires to the customer's premises. Published estimates on the overall cost to the service provider for CPE installation is on the order of $1000 per subscriber installation.

### SUMMARY OF INVENTION

The cost of providing data and voice service to customers is substantially reduced by having multiple customers share a single subscriber station (SS) of a wireless metropolitan area network (WMAN) through the use of a local area network formed using utility power lines. Typically, multiple customers share a single medium to low voltage transformer. The low voltage power lines between the houses are thus interconnected on the low voltage side of the transformer. Because the transformer blocks propagation of high frequency signals onto the medium voltage power lines, the low voltage lines extending between multiple customers can function as a shared medium for a local area network for just those customers sharing the transformer. Each electric power customer thus may use its electrical power lines to access a WMAN subscriber station using relatively low cost power line networking equipment that can be installed by the customer. Thus, the costs of a WMAN subscriber station can be distributed among more than one potential customer, and can be installed without running new wires or providing installation services for customer premise equipment.

### BRIEF DESCRIPTION OF DRAWINGS

FIG. 1 is a schematic diagram illustrating prior art use of low voltage AC power lines for home networking.

FIG. 2 is a schematic diagram illustrating prior art use of encryption keys to define logical networks for power line stations that share the same low voltage power line medium.

FIG. 3 is a schematic diagram illustrating an access bridge modem (ABM-WMAN-PL) that internetworks a wireless broadband access network with power line stations that share a common MV-to-LV utility power distribution transformer.

FIG. 4 is a schematic diagram illustrating use of encryption keys to define logical networks for maintaining separate broadband access service for individual power line stations.

FIG. 5 is a schematic diagram illustrating system architecture for bridging a fixed broadband wireless access network to a power line network, emphasizing software components, media-specific stations and network interfaces.

### DETAILED DESCRIPTION

In the following description, like numbers refer to like elements.

In the following description, a dual-medium bridge modem—one medium being free space and the other medium being the low-voltage power line—is used to connect a power line network to a fixed (antenna) broadband wireless access network. “Low voltage” in this context means the voltage presented to the ultimate utility power consumer, e.g., in the United States (US) the 115 volts alternating current (AC) at household or office wall sockets. This dual-medium bridge modem will also be referred to herein as an access bridge modem (ABM) for wireless metropolitan area networks (WMAN) and power line (PL) networks, or ABM-WMAN-PL for short.

A dual medium bridge for wireless metropolitan area network and a power line network has at least two physical or signaling interfaces: one for free space and one for wireline. Each interface has associated with it a media access controller (MAC) for communicating over the respective networks. The dual medium bridge modem also includes interworking logic that coordinates the exchange of data and control signals between the two networks. In an example of a preferred embodiment of an ABM-WMAN-PL described below, the two networks are a wireless metropolitan area network based on the IEEE 802.16® standard and a power line local area network (LAN) based on the HomePlugm standard.

The ABM-WMAN-PL is most advantageously mounted on a pole or tall object near the utility power distribution step-down (distribution) transformer for best reception. However, it and/or its antenna may be placed elsewhere. The ABM-WMAN-PL utilizes one or more antennas to communicate through free space with one or more base stations of a fix broadband wireless access (FBWA) network. The ABM-WMAN-PL uses the low voltage power line to communicate with one or more power line stations in the one or more homes or offices that receive utility power from the distribution transformer.

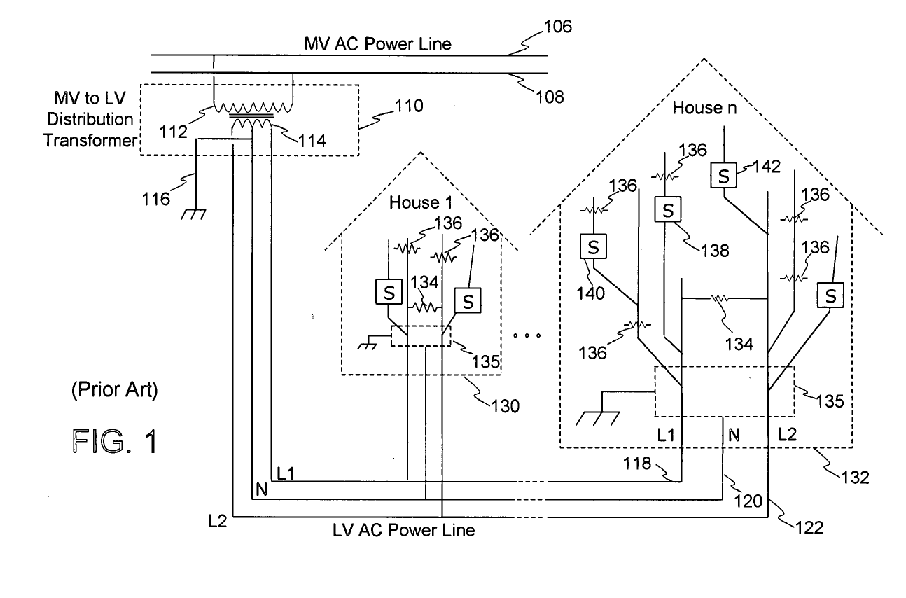

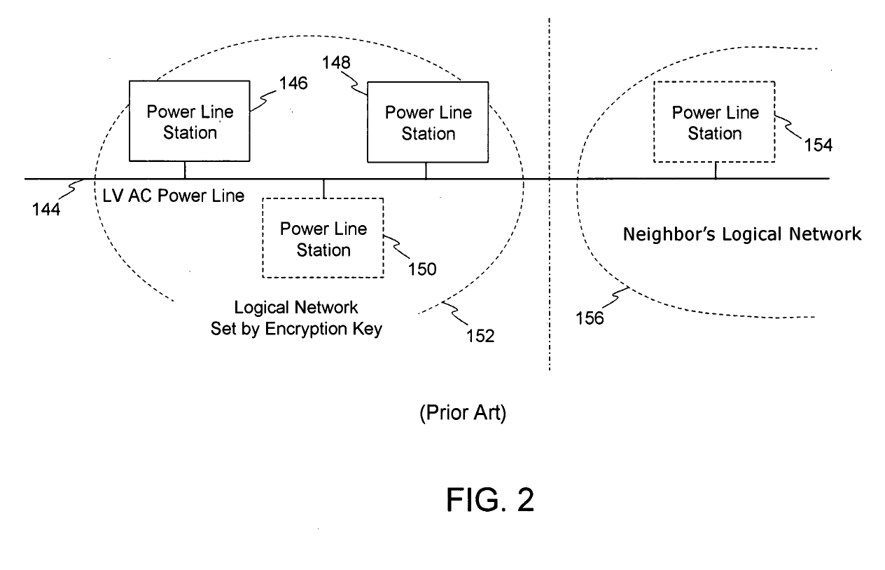

FIGS. 1 and 2 illustrate prior art methods of using a representative low voltage AC power line as a medium for power line network stations to establish a broadband, i.e., high data rate, local area network between data appliances, such as Ethernet routers, bridges, switches and personal computers.

Referring to FIG. 1, houses 1 to N share the same medium voltage (MV) to low voltage (LV) distribution transformer 110. The MV power lines 106 and 108 attach to the primary winding 112 of the MV to LV step down, distribution transformer 110. The transformer's secondary winding 114 provides three outputs, also called phases: neutral (N), line 1 (L1) and line 2 (L2). The center or neutral tap is connected to earth ground 116. Lines coming from these outputs are labeled 118 (L1), 120 (line N), and 122 (L2). They are collectively referred to as low voltage alternating current (AC) power line(s) and provide utility power to the houses 1 to n. In the United States, the number of houses n is typically 4 to 6 but may be up to 12, for example. Inside the houses the LV AC power lines encounter loads, which are indicated schematically in FIG. 1 by resistor symbols. Loads 134 are across the AC voltage of from L1 to L2, e.g., 230 volts (US). Loads 136 are across lines 118 or 122 and a local neutral line, e.g., line 120 or earth ground line 135, and are 115 volts (US).

Power line networking stations, indicated in the various figures by boxes labeled with “S”, are always connected to line L1 or L2 line and line N. For this reason, the communications path between any two power line stations within a house depends on whether the two stations happen to be on the same or different phase lines (L1 or L2). If the two stations, such as stations 138 and 140, are on the same line (L1), the power line distance between them is considerably less than if they are on different lines, such as stations 138 and 142. The power line path from an L1 station 138 to an L2 station 142, includes the L1 path 118 to the MV-LV transformer 110, the path through the secondary winding 114, and the L2 path back to the L2 station 142. Indeed, the prior art in the development of the power line stations for home networking requires that the L1-L2 communications (via the distribution transformer) be adequate for high speed data transfers. As a consequence, by design all of the power line stations in any of the n houses attached to the same MV-LV transformer 110 can communicate with each other.

FIG. 2 illustrates the use of encryption keys to define logical networks in the power line network stations, e.g. HomePlug™ standard compliant adaptors, bridges, routers and gateways, for home networking and other LAN applications. Although the power line stations of two different houses or offices share the same physical communications medium, namely the LV AC power lines 144, and can therefore receive each other's signals, the stations of the two houses are assigned different encryption keys to establish separate logical networks. The power line network stations 146, 148, and 150 of house 152 are logically connected to form a LAN by the mechanism of having a common encryption key. Power line station 154 of a neighboring house 156 is isolated from this LAN since it's encryption key does not match.

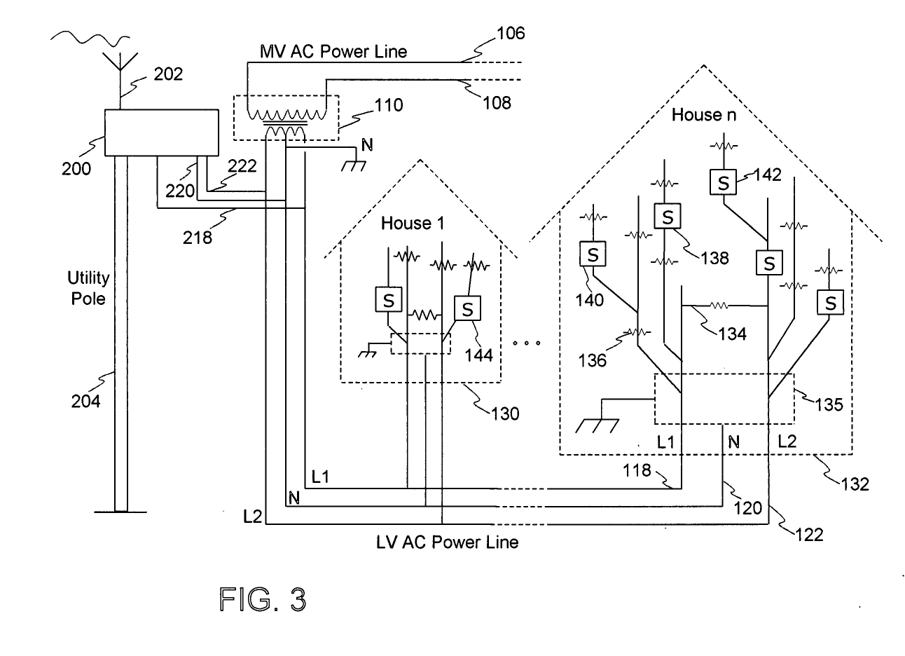

FIG. 3 shows a schematic diagram of the same, representative utility power distribution network shown in FIG. 1, with the addition of placement of an ABM-WMAN-PL 200 near MV-to-LV distribution transformer 110. The distribution transformer 110 is often elevated by attachment near the top of a utility pole 204, from which the MV power lines 106 and 108 are also attached. In this case, the placement of ABM-WMAN-PL 200 near the top of utility pole 204 and near distribution transformer 110 is especially advantageous. This allows the ABM-WMAN-PL 200 to be close to or integrated with antenna 202, which is preferably mounted on top of the utility pole 204. Such a mounting provides a good antenna height for receiving and transmitting the WMAN radio frequency (RF) signals. Being next to the distribution transformer 110 is desirable for the ABM-WMAN-PL since, as discussed above, the distribution transformer is a required communications path for all power line stations in all houses or offices that receive utility power from the distribution transformer. A power line station that resides in the ABM-WMAN-PL (not shown in this view) is then conveniently connected by means of wires 218, 220 and 222 to the L1, L2 and N lines that exit the distribution transformer 110. This placement assures that ABM-WMAN-PL unit 200 has uniformly good communication with all power line stations S connected to the distribution transformer's LV AC network. In the case of ground level MV-to-LV distribution transformers, antenna 202 can be elevated by attachment to a standalone pole or any available structure.

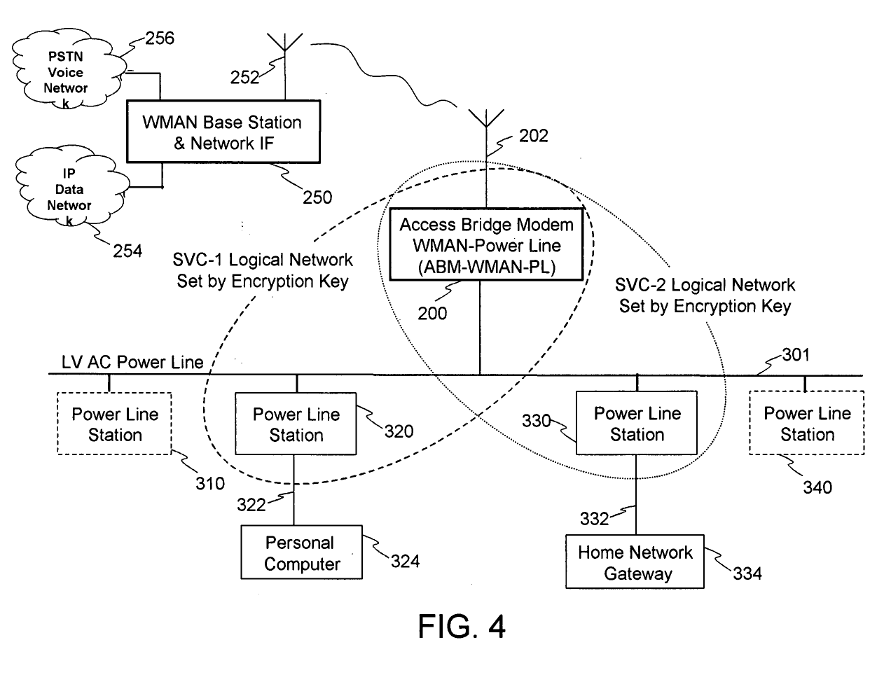

FIG. 4 illustrates how ABM-WMAN-PL unit 200 uses the encryption keys of the power line stations to maintain separate subscriber connections to the WMAN broadband access system. The ABM-WMAN-PL unit continuously maintains an active RF link with the WMAN base station 250 via their respective antennas 202 and 252. The WMAN base station 250 in turn communicates with one or more data or integrated services networks 254, which can be, for example, an Internet Protocol (IP) network, or other types of networks such as the Public Switched Telephone Network (PSTN) 256 for traditional voice services. The ABM-WMAN-PL unit 200 contains a power line station that is capable of supporting multiple encryption keys, one for each set of WMAN system services provisioned to clients served by the power line network. A house that subscribes to the WMAN broadband access service may be provisioned with one or more sets of services (voice, data, fax, etc.), depending on the service contract. A unique encryption key is used to establish s logical, local area network labeled in the figure as SVC-1 that provides, for example, broadband access to a personal computer 324 via the appropriate network interface cable 322 connecting it to power line network station 320. Similarly, a second logical local area network, labeled SVC-2, is established using a second unique encryption key and provide broadband access to, for example, home network gateway 334 via the appropriate network interface cable 332 connecting it to power line station 330. The use of encryption keys to set up logical local area networks permits different services sets to be delivered to different households, and even to different power line network stations within the same household, if desired, by setting up different stations with different encryption keys. Thus, for example, power line network stations 310 and 340 may be use the same power line medium without any access to the ABM-WMAN-PL unit 200, because they are not setup to share an encryption key, i.e. they have not been provisioned with an authorized service set.

As illustrated by the forgoing example, a low voltage AC power line network, convention, commercially available power line network stations, and an ABM-WMAN-PL, in conjunction with a service provider's WMAN base station, can be used to provide broadband access to high speed (Internet) data services as well as traditional voice telephone services. This broadband service can be provisioned at a relatively low equipment cost per subscriber, using low cost customer premise equipment (the power line network stations) installed by the customer without new wires or assistance of a technician.

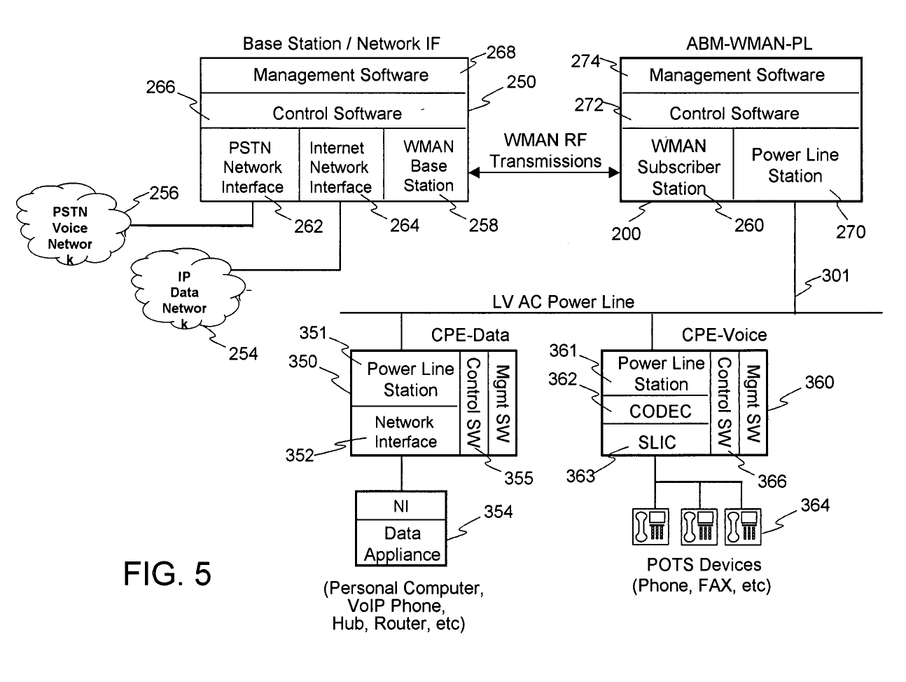

FIG. 5 schematically illustrates preferred embodiment of the basic structures of the major architectural elements of the examples given above. These include base station/network IF 250, ABM-WMAN-PL unit 200 and two power line CPE devices: the CPE-Data unit 350 and CPE-Voice unit 360. Each of these major elements has its own management software and control software. The schematic diagrams of these elements emphasize software components, media-specific stations and network interfaces.

The base station/network IF 250 basically contains the circuitry and software for a WMAN base station 258. This circuitry and software handles the functions of the physical and media access control (MAC) layers required of a WMAN base station to maintain a two-way RF link with WMAN subscriber station 260 contained in ABM-WMAN-PL unit 200. The base station/network IF element 250 may also contain network interfaces 262 and 264 to, for example, PSTN voice network 256 and the IP data network 254, respectively. Control software 266 of the base station/network IF 250 handles interworking functions between the MAC layer of base station 258 and the MAC layers of the network interfaces 262 and 264. Management software 268 is used to manage operation of the base station including, for example, provisioning of services.

The WMAN subscriber station 260 contains elements for handling the functions of the physical and MAC layers in order to provide a WMAN subscriber station that maintains an RF link with the WMAN base stations. The ABM-WMAN-PL unit 200 also includes a power line station 272 (i.e. circuitry and software for interfacing with a power line network) that communicates with one or more power line stations attached to the LV AC power lines 301 of its associated MV-to-LV distribution transformer (not shown). Control software 272 of the ABM-WMAN-PL unit 200 handles interworking functions between the MAC layer of the WMAN subscriber station 260 and the MAC layer of the power line station 270. Management software 274 handles operation of the ABM-WMAN-PL. The elements of the ABM-WMAN-PL are preferably integrated into the ABM-WMAN-PL unit, but need not be. They may, however, be discrete elements assembled or interconnected at the point of installation.

The CPE-data device 350 is an example of customer premise equipment suitable for connecting to a data appliance 354 to a power line network. Examples of a data appliance include a personal computer, a VoIP telephone, a network router, switch, or hub, and a “Wi-Fi” network access point (a wireless LAN based on the IEEE 802.11® Standard). CPE-data devices based on the HomePlug™ Standard are commercially available from several manufactures. A typical CPE-data device would include on one side power line station or interface 351 that communicates with the power line station of the ABM-WMAN-PL unit 200. The power line station has circuitry and software for handling physical and MAC layer functions. A typical CPE-data device also includes a network interface 352 that communicates with a network interface (NI) in data appliance 354 and control software 355 that performs interworking between the MAC layer of the power line station and the MAC layer of the network interface (NI).

The CPE-voice device 360 is also representative customer premise equipment suitable for connecting a telephone, fax machine or similar “POTS” device to a power line network. It contains circuit and software of a power line station 361 that communicates with the power line station of the ABM-WMAN-PL unit 200. The CPE-voice device 360 also contains a (code and decode) CODEC 362 and a (subscriber line interface card) SLIC 363 which provide an analog interface for a plain old telephone service (POTS) device 364, e.g., a standard telephone, modem or a FAX machine. Control software 366 of the CPE-voice device 360 performs the interworkings between the MAC layer of the power line station and that of the CODEC and SLIC. The CPE-Voice device can conveniently plug into an AC power outlet near a telephone jack. Once any pre-existing connection between the PSTN and the premise wiring has been broken, an inexpensive phone cord can then connect the CPE-Voice to the telephone jack and all connected telephone jacks in the residence will be supported.

1. Apparatus comprising:
a subscriber station for communicating with a base station of a fixed wireless access network;
a power line station for communicating over a power line network; and
internetworking logic for communicating between the subscriber station and power line station.

2. A wireless metropolitan area network, comprising:
a fixed wireless access network having at least one base station; and
a bridge modem, the bridge modem comprising
a subscriber station for communicating with the base station of the fixed wireless access network;
a power line station for communicating over a power line network; and
means for internetworking the subscriber station and power line station.

3. The wireless metropolitan area network of claim 2, wherein the bridge modem is coupled to a low voltage lines of a distribution power transformer.

4. Method of providing broadband access comprising:
providing a fixed wireless access network having a least one base station;
providing at least one subscriber station,
providing internetworking logic for communicating between the subscriber station and a power line station;
connecting the power line station to low voltage power distribution lines of a distribution power transformer;
setting up a virtual local area network over lower voltage power distribution lines on the low voltage lines to provide broadband communication services to one or more predetermined power line stations connected with the power line network.
